(19) United States
(12) Patent Application Publication
(10) Pub. No.: US 2016/0212813 A1
(43) Pub. Date: Jul. 21, 2016

(54) Method on digital deep dimming through combined PWM and PFM

(71) Applicant: BRIDGELUX, INC., Livermore, CA (US)

(72) Inventor: Xiangrong LI, Dublin, CA (US)

(21) Appl. No.: 14/757,904

(22) Filed: Dec. 23, 2015

Related U.S. Application Data
(60) Provisional application No. 62/096,526, filed on Dec. 23, 2014.

(51) Int. Cl. H05B 33/08

(52) U.S. Cl. CPC H05B 33/0845; H05B 33/0818

(57) ABSTRACT

Techniques and systems for deep dimming in an LED lighting system using any general microcontroller with a 16-bit timer/PWM module are provided. The techniques combines PWM (pulse width modulation) and PFM (pulse frequency modulation), and makes use of standard features of general microcontroller to reach a deep dimming level (such as 0.1% of the maximum output) without special hardware between microcontroller outputs to LED array. The overall complexity and cost are reduced while the lighting performance stays at high level. The methods and systems reduce the overall complexity of the LED driver circuits used to reach deep dimming, while also reducing the cost for achieving deep dimming in an LED lighting system. Additionally, the techniques and systems are able to maintain high switching frequency for most of the dimming range, which allows for flicker-free dimming performance.

### CROSS-REFERENCE TO RELATED APPLICATION

This application claims priority to U.S. provisional patent application No. 62/096,526 entitled “METHOD ON DIGITAL DEEP DIMMING THROUGH COMBINED PWM AND PFM,” filed Dec. 23, 2014, which is hereby fully incorporated by reference in its entirety.

### BACKGROUND OF THE INVENTION

1. Field of the Invention

The present invention generally relates to smart lighting, and more particularly to a dimming in a lighting system using light emitting diodes (LED).

2. Background

With the wide-spread application of digital dimming, deep dimming has become a requirement for more lighting applications. In order to achieve deep dimming such as 0.1%, special made LED drivers or integrated lighting control hardware inside microcontrollers is needed, which is expensive and cumbersome to use. Embodiments described herein solve these problems by providing a way to accomplish deep dimming using a general microcontroller without the need for imposing additional requirements on other components of the LED driver system.

With the emergence of digital dimming, the requirements on lighting quality are increasing to higher standard all the time. Especially in lighting control, the dimming range is one of the most important features in digital lighting system. When many LED fixtures today are dimmed, they can shut off completely at around 10% to 20% light level on the dimming scale due to practical limits imposed by their power supply minimum-voltage requirements. This is a problem because deep dimming capability down to 0.1% of the maximum power output is desirable and has a considerably large market in commercial applications.

The traditional dimming approach (TRIAC dimmer for example) is limited by the hardware it utilizes to reach deep dimming level. With the advancing of processor technology, micro-control units (MCU) have become more powerful and less expensive and are becoming more adopted in lighting control applications. Digitally controlled lighting systems provide more possibilities for higher dimming quality requirements. Although there exists solutions in the market capable of dimming to 0.1% levels that use digital controls, these solutions require either special hardware or special lighting control modules inside the microcontroller.

Therefore, there is a need for a cost effective dimming solution that can be used to dim the light output in an LED lighting system.

### SUMMARY OF THE INVENTION

Accordingly, embodiments are directed to techniques and systems that can be used for deep dimming in an LED lighting system.

Embodiments provide techniques and systems for deep dimming that can be achieved on any general microcontroller with 16-bit timer module with capture/compare function. The method combines PWM (pulse width modulation) and PFM (pulse frequency modulation), and makes use of standard features found in general microcontrollers to achieve a deep dimming level (such as 0.1% of the maximum output) without utilizing special hardware within the microcontroller and/or between the microcontroller outputs and the LED array. The overall complexity and cost are reduced while the lighting performance stays at high level. The methods and systems reduce the overall complexity of the LED driver circuits used to reach deep dimming, while also reducing the cost for achieving deep dimming in an LED lighting system. Additionally, the techniques and systems are able to maintain high switching frequency for most of the dimming range, which allows for flicker-free dimming performance.

In some embodiments, the methods and systems described herein enable the achievement of deep dimming down to a deep dimming level of the maximum light output with standard features of general microcontroller, without additional external hardware, such as power converter and LED drivers. In one example, the deep dimming level of the maximum light output is 0.1% deep dimming level.

It is understood that other aspects of apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses will now be presented in the detailed description by way of example, and not by way of limitation, with reference to the accompanying drawings, wherein:

FIG. 1 is shows a Lehman/Wilkins flicker risk graph.

FIG. 2 is an illustration showing a comparison of PWM and PFM dimming.

FIG. 3 is an illustration showing amplitude vs timing in the PWM, transition, and PFM dimming regions.

FIG. 4 shows a PWM dimming region with 50% duty cycle.

FIG. 5 is test data showing a PWM and PFM transition point with a predefined duty cycle measured on a microcontroller PWM output pin.

FIG. 6 is test data showing a PFM dimming region to a target deep dimming level of the maximum light output (e.g. with 0.1% duty cycle).

### DETAILED DESCRIPTION OF THE ILLUSTRATED EMBODIMENTS

Various aspects of the invention will be described herein with reference to drawings that are schematic illustrations of idealized configurations of the present invention. As such, variations from the shapes of the illustrations resulting from manufacturing techniques, tolerances, etc., are to be expected. Thus, the various aspects of the invention presented throughout this disclosure should not be construed as limited to the particular shapes of elements (e.g., regions, layers, sections, substrates, etc.) illustrated and described herein, but are to include deviations in shapes that result, for example, from manufacturing. By way of example, an element illustrated or described as a rectangle may have rounded or curved features and/or a gradient concentration at its edges rather than a discrete change from one element to another.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements disclosed as being on the “lower” side of other elements would then be oriented on the “upper” side of the other elements. The term “lower” can therefore encompass both an orientation of “lower” and “upper,” depending on the particular orientation of the apparatus. Similarly, if an apparatus in the drawing is turned over, elements described as “below” or “beneath” other elements would then be oriented “above” the other elements. The terms “below” or “beneath” can therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Furthermore, various descriptive terms used herein, such as “on” and “transparent,” should be given the broadest meaning possible within the context of the present disclosure. It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. In addition, something that is described as being “transparent” should be understood as having a property that allows no significant obstruction or absorption of electromagnetic radiation in the particular wavelength (or wavelengths) of interest, unless a particular transmittance is provided. It will be further understood that when an element is referred to as being “formed” on another element, it can be grown, deposited, etched, attached, connected, coupled, or otherwise prepared or fabricated on the other element or an intervening element.

Embodiments provide techniques and systems for deep dimming that can be achieved on any general microcontroller with 16-bit timer module with capture/compare function. The method combines PWM (pulse width modulation) and PFM (pulse frequency modulation), and makes use of standard features found in general microcontrollers to achieve a deep dimming level (such as 0.1% of the maximum output) without utilizing special hardware within the microcontroller and/or between the microcontroller outputs and the LED array. The overall complexity and cost are reduced while the lighting performance stays at high level. The methods and systems reduce the overall complexity of the LED driver circuits used to reach deep dimming, while also reducing the cost for achieving deep dimming in an LED lighting system. Additionally, the techniques and systems are able to maintain high switching frequency for most of the dimming range, which allows for flicker-free dimming performance.

In some embodiments, the methods and systems described herein enable the achievement of deep dimming down to a deep dimming level of the maximum light output with standard features of general microcontroller, without additional external hardware, such as power converter and LED drivers. In one example, the deep dimming level of the maximum light output is 0.1% deep dimming level.

It is advantageous and efficient to use the PWM output of a microcontroller as the control signal to a driver that drives LED arrays. Nevertheless, in deep dimming applications, PWM control of dimming is limited by the following factors:
1) The deep dimming level of the maximum light output requirement is typically 0.1%.
2) The PWM frequency requirement is overall 1 kHz.
3) The clock speed or minimum ON time for general LED drivers is typically 4-20 microseconds.

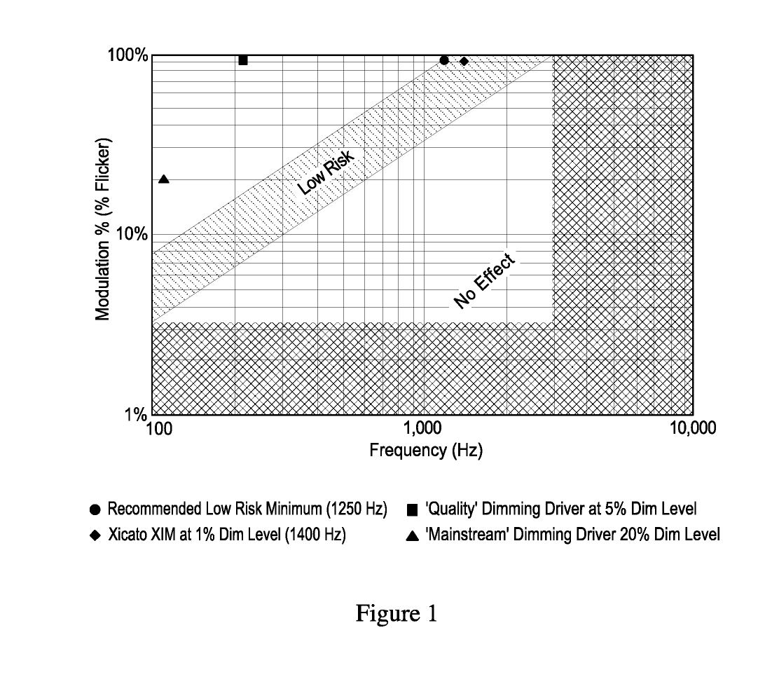

FIG. 1 shows a Lehman/Wilkins flicker risk graph. According to FIG. 1, low dimming switching frequency tends to cause flicker. For better performance, a switching frequency over 1 kHz is desired to avoid flicker in most dimming ranges.

On the other hand, because of limitations with general LED drivers, the switching lighting control signal needs to maintain a minimum ON time for driver output slew rate as well as other delays caused by the capacitive and/or inductive components in the driver design.

Approach with PWM Only

As a result, if the minimum deep dimming level of the maximum light output is required at Dmin=0.1%, and the LED driver minimum ON time TON=10 microseconds, then the switching frequency at the lowest dimming level can be calculated as:

$${f}_{max} = \frac{{D}_{min}}{{T}_{ON}} = 100 Hz$$

As appreciated by those skilled in the art, this frequency is way too low to avoid flickers.

Another approach to work around is to keep the PWM frequency at over 1 kHz for dimming levels above a certain threshold level:

Dₘᵢₙ=f×T_{ON}=1%

In this way, for most of the dimming range, the switching frequency is flicker free or at low risk. When dimmed to the deep dimming region under 1%, switch the PWM frequency to as low as 100 Hz.

To switch the PWM frequency while maintaining the duty cycle, several approaches were tested, including:
1) Change the PWM on time and period at the same time.
2) Change the prescaler of the clock signal driving the PWM module.
3) Change the internal PWM prescaler

However, it seems that the change of PWM frequency (same duty cycle based on Cypress PSoC 4200 microcontroller) causes a flicker on the LED output, which is not desirable.

Approach with PFM Only

With the minimum ON time limit of the LED driver, it is advantages to think of PFM as the solution. In this way, the pulse width (ON time) is kept constant while the repetition rate (frequency) of the pulse is changing.

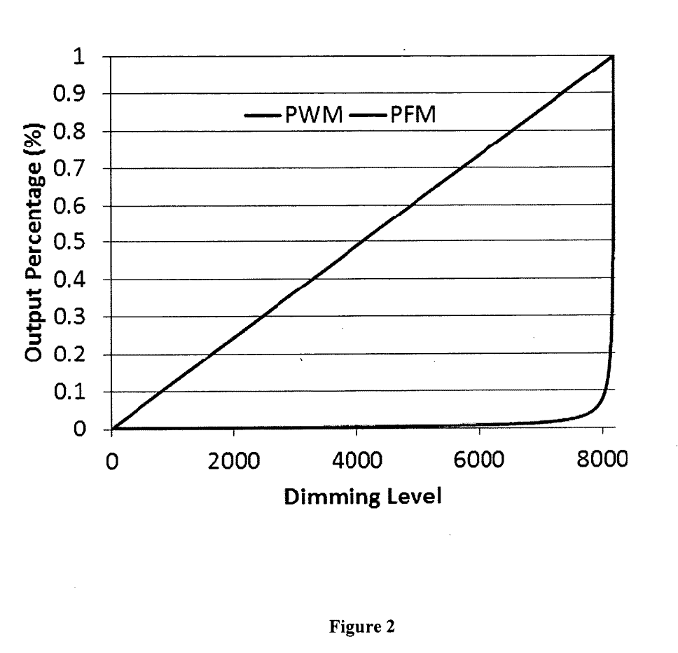

However, according to theoretical calculation, PFM only approach has excellent control resolution at low dimming range, but the resolution decreases when the dimming level is over 50%, as illustrated in FIG. 2. FIG. 2 is an illustration showing a comparison of PWM and PFM dimming.

According to FIG. 2 the resolution of PFM is not balanced throughout the dimming range. The lack of resolution at higher dimming level will cause more stepping in light output.

Combination of PWM and PFM

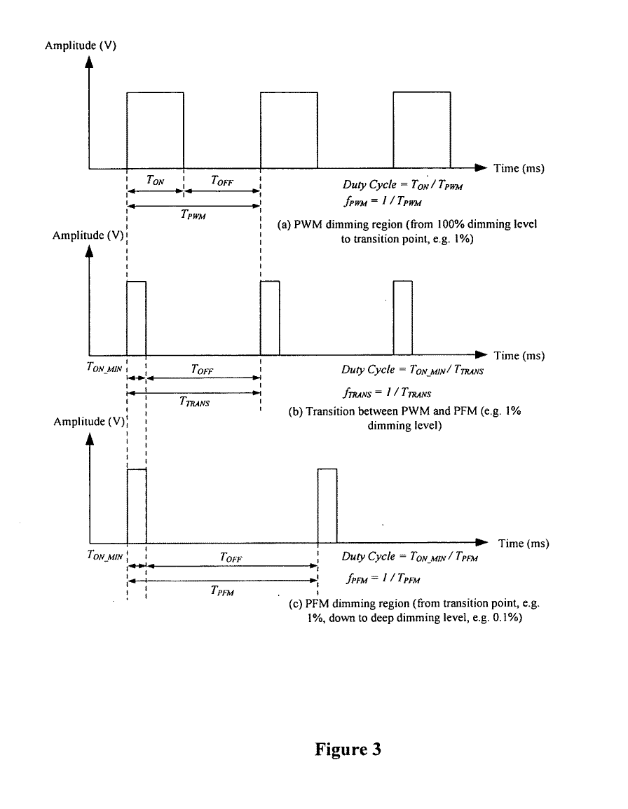

In order to combine the advantages of PWM and PFM, the method uses both PWM and PFM to achieve dimming in different dimming ranges as illustrated in FIG. 3. FIG. 3 is an illustration showing amplitude vs timing in the PWM, transition, and PFM dimming regions:
a) 1%˜100%: use PWM only. Higher PWM frequency is used to guarantee flicker-free dimming performance, while good dimming resolution is maintained.
b) 1%: This is the transition point between the PWM and PFM regions.
c) 0.1%˜1%: use PFM only. Minimum ON time of LED driver is met, which deep dimming down to 0.1% can be achieved without abrupt change of switching frequency

The detailed test result is discussed in the “Implementation” section below.

Implementation

The method can be used on any microcontroller with 16-bit timer/PWM module. Initial testing was performed on a lighting integrated smart module (ISM) printed circuit board (PCBA) platform which utilizes a Cypress PSoC CY8C4245LQI-483 microcontroller and TI LM3463 LED driver with Vero 18 LED array.

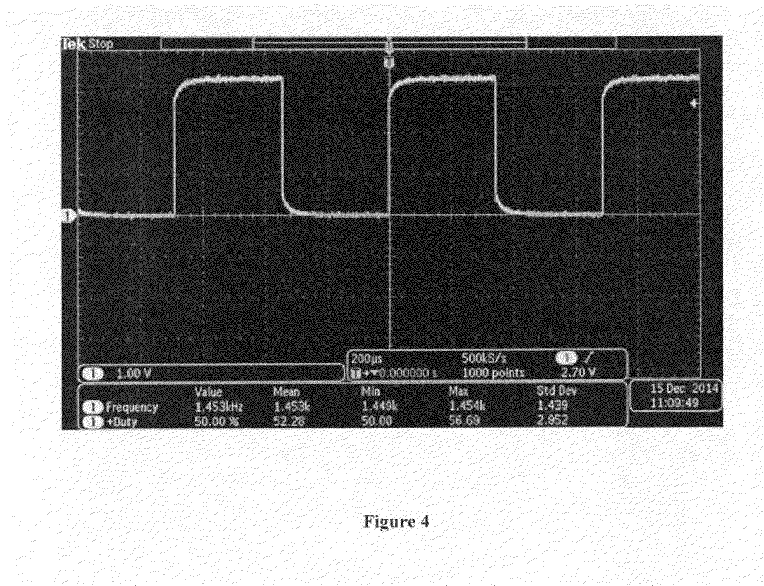

For a dimming level between the transition point level of the maximum light output to 100% of the maximum light output, PWM is used to dim the LED array. The PWM frequency is set at 1.45 kHz to guarantee flicker-free dimming performance. The resolution in this region is 12-bit (4096 steps). See FIG. 4 for test result. FIG. 4 shows a PWM dimming region with 50% duty cycle. In one example the transition point level of the maximum light output is 1.17% of the maximum light output.

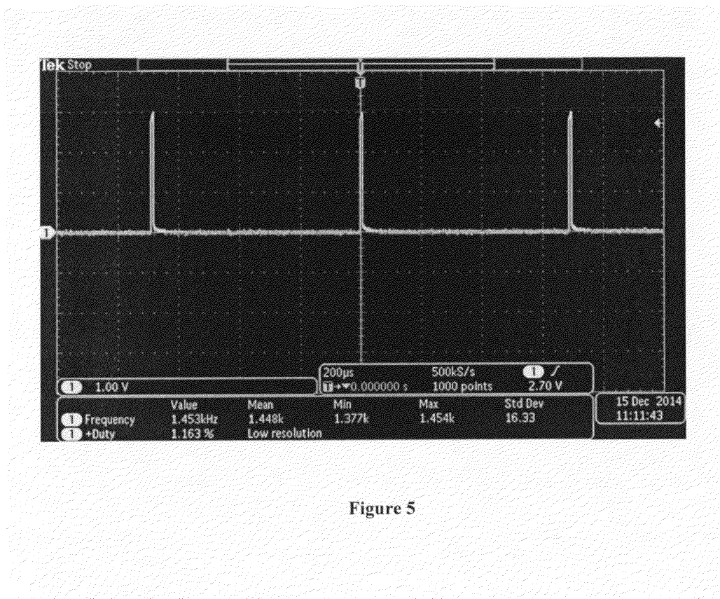

For dimming level at the transition point level of the maximum light output, the pulse ON time can be 8 microseconds, which is the minimum ON time limited by the TI LM3463 LED driver. This is set as the minimum duty cycle of the PWM region. Also, the pulse width is used as the fixed pulse width for PFM region if further dimming down is preferred. The switching frequency at this point is kept at 1.45 kHz at this transition point. See FIG. 5 for test result. FIG. 5 is test data showing a PWM and PFM transition point with a predefined duty cycle measured on a microcontroller PWM output pin.

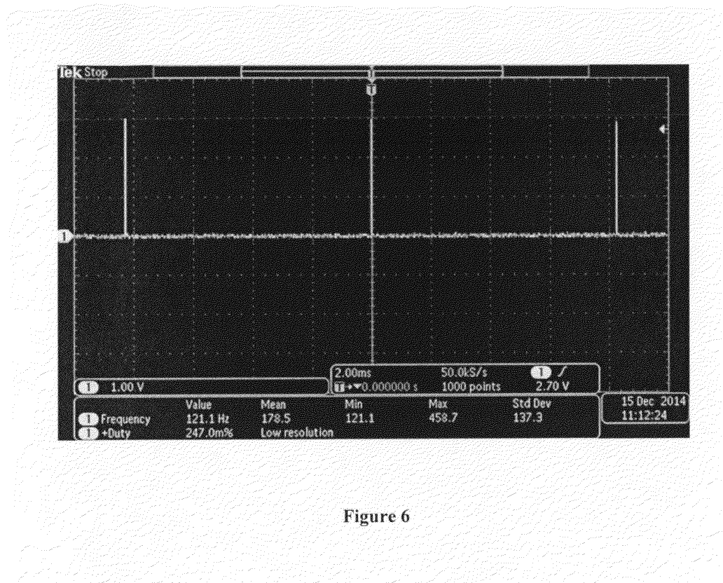

For dimming level between 0.1% of the maximum light output (deep dimming level) and the transition point level of the maximum light output, PFM is used to dim the LED array. A fixed pulse width of 8 microseconds is utilized in order to meet the LED driver limit. The switching frequency decreases from 1.45 kHz at the transition point level of the maximum light output down to 122 Hz at the 0.1% of the maximum light output (deep dimming level). See FIG. 6 for test results. FIG. 6 is test data showing a PFM dimming region to a target deep dimming level of the maximum light output (e.g. with 0.1% duty cycle).

In one embodiment a method of a changing light output in a light emitting diode (LED) system includes dimming a light output of the LED system between 100% of a maximum light output and a transition point level of the maximum light output using pulse width modulation (PWM), and dimming the light output of the LED system between the transition point level of the maximum light output and a deep dimming level of the maximum light output using pulse frequency modulation (PFM). The transition point level can be predetermined based on a dimming performance requirement and an LED driver capability. In one example the transition point level is less than 1.2% of the maximum light output. The deep dimming level can be predetermined based on a dimming performance requirement and an LED driver capability. In one example, the deep dimming level is equal to 0.1% of the maximum light output.

In certain embodiments, dimming using PWM utilizes providing power to the LED system at a frequency of 1.45 kHz. In other embodiments, dimming using PWM utilizes providing power to the LED system at a frequency of 1.45 kHz with a 12-bit (4096 steps) resolution.

In some embodiments, the method of changing light output in a light emitting diode (LED) system further includes transitioning between PWM and PFM as the light output is reduced to below the transition point level of the maximum light output.

In some embodiments, dimming the light output of the LED system between the transition point level of the maximum light output to the deep dimming level of the maximum light output using PFM further includes using a fixed pulse width.

In some embodiments, dimming the light output of the LED system between the transition point level of the maximum light output to the deep dimming level of the maximum light output using PFM further comprises changing the switching frequency between above 1.0 kHz at the transition point level and below 500 Hz at the deep dimming level.

In some embodiments, dimming the light output of the LED system between the transition point level of the maximum light output to the deep dimming level of the maximum light output using PFM further includes dimming using a fixed pulse width, dimming by changing the switching frequency between above 1.0 kHz at the transition point level and below 500 Hz at the deep dimming level, and wherein the frequency is changed between above 1.0 kHz at the transition point level and below 500 Hz step-wise continuously.

In some embodiments, dimming a light output of the LED system between 100% of a maximum light output and a transition point level of the maximum light output using PWM further comprises using a fixed pulse frequency.

In some embodiments, dimming a light output of the LED system between 100% of a maximum light output and a transition point level of the maximum light output using PWM further comprises changing the pulse width between a predetermined minimum pulse width at the transition point level and equal to pulse period at the 100% of a maximum light output.

In some embodiments, dimming a light output of the LED system between 100% of a maximum light output and a transition point level of the maximum light output using PWM, further includes dimming using a fixed pulse frequency, changing the pulse width between a predetermined minimum pulse width at the transition point level and equal to pulse period at the 100% of a maximum light output, and wherein the pulse width is changed between the predetermined minimum pulse width at the transition point level and equal to pulse period at the 100% of a maximum light output step-wise continuously.

In some embodiments, a light emitting diode (LED) system, includes an LED array, a microcontroller configured to provide a pulse width modulated signal and a pulse frequency modulated signal, and a driver. The driver is configured to receive the pulse width modulated signal or pulse frequency modulated signal from the microcontroller and drive the LED array. The driver can be further configured to drive internal or external switching components that drive the LED array. The microcontroller can provide the pulse width modulated signal or pulse frequency modulated signal depending on a predetermined dimming level. The microcontroller can include a 16 bit timer module with a capture/compares function.

The inventions and methods described herein can be viewed as a whole, or as a number of separate inventions that can be used independently or mixed and matched as desired. All inventions, steps, processes, devices, and methods described herein can be mixed and matched as desired. All previously described features, functions, or inventions described herein or by reference may be mixed and matched as desired.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of a changing light output in a light emitting diode (LED) system, comprising:
dimming a light output of the LED system between 100% of a maximum light output and a transition point level of the maximum light output using pulse width modulation (PWM); and
dimming the light output of the LED system between the transition point level of the maximum light output and a deep dimming level of the maximum light output using pulse frequency modulation (PFM).

2. The method of claim 1, wherein the transition point level is predetermined based on a dimming performance requirement and an LED driver capability.

3. The method of claim 1, wherein the transition point level is less than 1.2% of the maximum light output.

4. The method of claim 1, wherein the deep dimming level is predetermined based on a dimming performance requirement and an LED driver capability.

5. The method of claim 1, wherein the deep dimming level is equal to 0.1% of the maximum light output.

6. The method of claim 1, wherein dimming using PWM utilizes providing power to the LED system at a frequency of 1.45 kHz.

7. The method of claim 1, wherein dimming using PWM utilizes providing power to the LED system at a frequency of 1.45 kHz with a 12-bit (4096 steps) resolution.

8. The method of claim 1 further comprising transitioning between PWM and PFM as the light output is reduced to below the transition point level of the maximum light output.

9. The method of claim 1, wherein dimming the light output of the LED system between the transition point level of the maximum light output to the deep dimming level of the maximum light output using PFM further comprises using a fixed pulse width.

10. The method of claim 1, wherein dimming the light output of the LED system between the transition point level of the maximum light output to the deep dimming level of the maximum light output using PFM further comprises changing the switching frequency between above 1.0 kHz at the transition point level and below 500 Hz at the deep dimming level.

11. The method of claim 1, wherein dimming the light output of the LED system between the transition point level of the maximum light output to the deep dimming level of the maximum light output using PFM further comprises:
dimming using a fixed pulse width; and
dimming by changing the switching frequency between above 1.0 kHz at the transition point level and below 500 Hz at the deep dimming level,
wherein the frequency is changed between above 1.0 kHz at the transition point level and below 500 Hz step-wise continuously.

12. The method of claim 1, wherein dimming a light output of the LED system between 100% of a maximum light output and a transition point level of the maximum light output using PWM further comprises using a fixed pulse frequency.

13. The method of claim 1, wherein dimming a light output of the LED system between 100% of a maximum light output and a transition point level of the maximum light output using PWM further comprises changing the pulse width between a predetermined minimum pulse width at the transition point level and equal to pulse period at the 100% of a maximum light output.

14. The method of claim 1, wherein dimming a light output of the LED system between 100% of a maximum light output and a transition point level of the maximum light output using PWM, further comprises:
dimming using a fixed pulse frequency; and
changing the pulse width between a predetermined minimum pulse width at the transition point level and equal to pulse period at the 100% of a maximum light output,
wherein the pulse width is changed between the predetermined minimum pulse width at the transition point level and equal to pulse period at the 100% of a maximum light output step-wise continuously.

15. A light emitting diode (LED) system, comprising:
an LED array;
a microcontroller configured to provide a pulse width modulated signal and a pulse frequency modulated signal; and
a driver configured to:
receive the pulse width modulated signal or pulse frequency modulated signal from the microcontroller; and
drive the LED array.

16. The LED system of claim 15 wherein the driver is further configured to drive internal or external switching components that drive the LED array.

17. The LED system of claim 15 wherein the microcontroller provides the pulse width modulated signal or pulse frequency modulated signal depending on a predetermined dimming level.

18. The LED system of claim 15 wherein the microcontroller comprises a 16 bit timer module with a capture/compares function.
